(19) United States
(12) Patent Application Publication
(10) Pub. No.: US 2018/0335371 A1
(43) Pub. Date: Nov. 22, 2018

(54) SYSTEMS AND METHODS FOR IMPLEMENTING IMPROVED LOSS OF SIGNIFICANCE SOLUTIONS

(71) Applicant: General Electric Company, Schenectady, NY (US)

(72) Inventor: Kenneth G. Kungania, Atlanta, GA (US)

(21) Appl. No.: 15/601,436

(22) Filed: May 22, 2017

(51) Int. Cl. G01M 99/00; G06F 7/50; G01M 13/00; G08B 21/18

(52) U.S. Cl. CPC G01M 99/008; G08B 21/182; G01M 13/00; G06F 7/50

(57) ABSTRACT

Embodiments of the disclosure relate to systems and methods for implementing improved loss of significance solutions. In one embodiment, a method can include receiving, by at least one computer processor, a first string of sequential numeric digits associated with operation of a machine. The method can further include separating the first string of sequential numeric digits comprising at least a first alpha segment and a first beta segment. The method can also include receiving one or more subsequent strings of sequential numeric digits associated with the operation of the machine. The method can also include separating each of the one or more subsequent strings of sequential numeric digits comprising at least a subsequent alpha segment and a subsequent beta segment. The method can include adding together the first alpha segment and one or more subsequent alpha segments to obtain an accumulated alpha value, and adding together the first beta segment and one or more subsequent beta segments to obtain an accumulated beta value.

### TECHNICAL FIELD

Embodiments of the disclosure generally relate to improving data measurements, and more particularly to, systems and methods for implementing improved loss of significance solutions.

### BACKGROUND

Conventional technologies have driven the need for more accuracy of data. In the computer domain, numbers are stored in floating point format. Loss of significance is a known issue in arithmetic for computers since most arithmetic is performed using floating point calculations. For example, for floating values, 1.2 minus 1 may, in certain instances, not equal 0.2.

### BRIEF DESCRIPTION OF THE DISCLOSURE

Certain embodiments of the disclosure may include systems and methods for implementing improved loss of significance solutions. According to one embodiment of the disclosure, a computer-implemented method can be provided. The method can include receiving, by at least one computer processor, a first string of sequential numeric digits associated with operation of a machine. The method can also include separating at least a portion of the first string of sequential numeric digits comprising at least a first alpha segment and a first beta segment. The method can also include receiving one or more subsequent strings of sequential numeric digits associated with the operation of the machine. Further, the method can include separating each of the one or more subsequent strings comprising at least a subsequent alpha segment and a subsequent beta segment. Further, the method can include adding together the first alpha segment and one or more subsequent alpha segments to obtain an accumulated alpha value. Moreover, the method can include adding together the first beta segment and one or more subsequent beta segments to obtain an accumulated beta value. Further, the method can include monitoring at least one of the accumulated alpha value or the accumulated beta value against a target value. The method can also include based at least in part on meeting or exceeding the target value, generating an alert or message indicative of the target value being met.

In at least one aspect of an embodiment, the method can further include based at least in part on the accumulated beta value, determining an excess value that exceeds the target value, and adding the excess value to the accumulated alpha value.

In at least one aspect of an embodiment, separating at least a portion of the first string of sequential numeric digits comprising at least a first alpha segment and a first beta segment, can include based at least in part on a condition associated with operation of the machine, determining a length of the first alpha segment and a length of the first beta segment.

In at least one aspect of an embodiment, each of the first alpha segment, second alpha segment, the one or more subsequent alpha segments, and the one or more subsequent beta segments are 16 bits in length.

In at least one aspect of an embodiment, the target value represents a value associated with a threshold indicating a predefined amount of a condition to a machine or a machine component.

In at least one aspect of an embodiment, the condition can include at least one of the following: damage, remaining life, creep life, or creep damage.

In at least one aspect of an embodiment, the machine can include a turbine or a power plant component.

According to one embodiment of the disclosure, a system can be provided. The system can include a controller and a memory with computer-executable instructions. The computer-executable instructions can be operable to receive, by at least one computer processor, a first string of sequential numeric digits associated with operation of a machine. The computer-executable instructions can be further operable to separate at least a portion of the first string of sequential numeric digits comprising at least a first alpha segment and a first beta segment. The computer-executable instructions can be further operable to receive one or more subsequent strings of sequential numeric digits associated with the operation of the machine. Further, the computer-executable instructions can be operable to separate each of the one or more subsequent strings comprising at least a subsequent alpha segment and a subsequent beta segment. Further, the computer-executable instructions can be operable to add together the first alpha segment and one or more subsequent alpha segments to obtain an accumulated alpha value. Moreover, the computer-executable instructions can be operable to add together the first beta segment and one or more subsequent beta segments to obtain an accumulated beta value. Moreover, the computer-executable instructions can be operable to monitor at least one of the accumulated alpha value or the accumulated beta value against a target value. The computer-executable instructions can also be operable to generate, based at least in part on meeting or exceeding the target value, an alert or message indicative of the target value being met.

In at least one aspect of an embodiment, the computer-executable instructions cam be further operable to determine, based at least in part on the accumulated beta value, an excess value that exceeds the target value, and add the excess value to the accumulated alpha value.

In at least one aspect of an embodiment, the computer-executable instructions operable to separate at least a portion of the first string of sequential numeric digits comprising at least a first alpha segment and a first beta segment, can include computer-executable instructions operable determine, based at least in part on a condition associated with operation of the machine, a length of the first alpha segment and a length of the first beta segment.

In at least one aspect of an embodiment, each of the first alpha segment, second alpha segment, the one or more subsequent alpha segments and the one or more subsequent beta segments are 16 bits in length.

In at least one aspect of an embodiment, the target value represents a value associated with a threshold indicating a predefined amount of a condition to a machine or a machine component.

In at least one aspect of an embodiment, the condition can include at least one of the following: damage, remaining life, creep life, or creep damage.

In at least one aspect of an embodiment, the machine can include a turbine or a power plant component.

According to one embodiment of the disclosure, another system can be provided. The system can include a power plant component, a controller, and a memory comprising computer-executable instructions. The computer-executable instructions can be operable to receive, by at least one computer processor, a first string of sequential numeric digits associated with operation of the power plant component. Further, the computer-executable instructions can be operable to separate at least a portion of the first string of sequential numeric digits comprising at least a first alpha segment and a first beta segment. Moreover, the computer-executable instructions can be operable to receive one or more subsequent strings of sequential numeric digits associated with the operation of the machine. Further, the computer-executable instructions can be operable to separate each of the one or more subsequent strings of sequential numeric digits comprising at least a subsequent alpha segment and a subsequent beta segment. The computer-executable instructions can be further operable to accumulate the first alpha segment and one or more subsequent alpha segments to obtain an accumulated alpha value. The computer-executable instructions can be further operable to accumulate the first beta segment and one or more subsequent beta segments to obtain an accumulated beta value. Further, the computer-executable instructions can be operable to monitor at least one of the accumulated alpha value or the accumulated beta value against a target value. Further, the computer-executable instructions can be operable to determine, based at least in part on the accumulated beta value, an excess value that exceeds the target value. The computer-executable instructions can be operable to add the excess value to the accumulated alpha value. Further, the computer-executable instructions can be operable to, generate, based at least in part on meeting or exceeding the target value, an alert or message indicative of the target value being met. Moreover, the computer-executable instructions can be operable to facilitate generating, based at least in part on the alert, a recommendation for a corrective action or a signal to initiate a corrective action with respect to the power plant component.

In at least one aspect of an embodiment, the computer-executable instructions operable to separate at least a portion of the first string of sequential numeric digits comprising at least a first alpha segment and a first beta segment, can include computer-executable instructions operable to determine, based at least in part on a condition associated with operation of the power plant component, a length of the first alpha segment and a length of the first beta segment.

In at least one aspect of an embodiment, each of the first alpha segment, second alpha segment, the one or more subsequent alpha segments and the one or more subsequent beta segments are 16 bits in length.

In at least one aspect of an embodiment, the target value represents a value associated with a threshold indicating a predefined amount of a condition to a power plant component.

In at least one aspect of an embodiment, the condition can include at least one of the following: damage, remaining life, creep life, or creep damage.

In at least one aspect of an embodiment, the first string of sequential numeric digits associated with operation of the power plant component can include measurement data from one or more sensors.

Other embodiments, features, and aspects of the disclosure will become apparent from the following description taken in conjunction with the following drawings.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates an example system environment in accordance with certain embodiments of the disclosure.

FIG. 2A illustrates an example calculation for a method in accordance with certain embodiments of the disclosure.

FIG. 2B illustrates example calculations for a method in accordance with certain embodiments of the disclosure.

FIG. 3 illustrates an example numeric string with segments in accordance with certain embodiments of the disclosure.

FIG. 4 illustrates an example logic flow in accordance with certain embodiments of the disclosure.

FIG. 5 illustrates an example method in accordance with certain embodiments of the disclosure.

FIG. 6 is a block diagram illustrating an example controller in accordance with certain embodiments of the disclosure.

The disclosure now will be described more fully hereinafter with reference to the accompanying drawings, in which example embodiments of the disclosure are shown. The following detailed description includes references to the accompanying drawings, which form part of the detailed description. The drawings depict illustrations, in accordance with example embodiments. This disclosure may, however, be embodied in many different forms and should not be construed as limited to the example embodiments set forth herein; rather, these example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents. Like numbers refer to like elements throughout.

### DETAILED DESCRIPTION

Certain embodiments of the disclosure described herein relate to systems and methods for implementing improved loss of significance solutions. Due to the amount of data being generated from any number of machines, contexts, and/or environments, relatively long strings of data represented by sequential numeric digits may not be accurately stored since a memory or data storage device being used to store the relatively long strings of data represented by sequential numeric digits may only use a predefined or fixed number of bits to store the data. For example, in some conventional memory devices, only 16 bits of data in a data string can be stored. When a numeric string of 32 sequential digits is received, the 32 digits must be truncated or otherwise shortened to 16 bits or sequential digits to be stored in the conventional memory device, resulting in the loss of the other 16 bits or sequential digits.

In one embodiment of the disclosure, a computer-implemented method can be provided. The method can include receiving, by at least one computer processor, a first string of sequential numeric digits associated with operation of a machine. The method can also include separating at least a portion of the first string of sequential numeric digits into at least t a first alpha segment and a first beta segment. The method can also include receiving one or more subsequent strings of sequential numeric digits associated with the operation of the machine. Further, the method can include separating each of the one or more subsequent strings of sequential numeric digits into at least a subsequent alpha segment and a subsequent beta segment. Further, the method can include adding together the first alpha segment and one or more subsequent alpha segments to obtain an accumulated alpha value. Moreover, the method can include adding together the first beta segment and one or more subsequent beta segments to obtain an accumulated beta value. Further, the method can include monitoring at least one of the accumulated alpha value or the accumulated beta value against a target value. The method can also include based at least in part on meeting or exceeding the target value, generating an alert or message indicative of the target value being met.

A “machine”, as used herein, can be any device that is capable of being monitored, measured, or otherwise provides numeric data to a processor, controller, or computer. A “machine” as used in numerous examples of the specification can refer to a power plant or any component of a power plant, such as a turbine or turbine component.

One will recognize the applicability of embodiments of the disclosure to any number of machines, contexts, and/or implementations. One or more technical effects associated with certain embodiments herein may include, but are not limited to, increasing processing efficiency and computational speed of a controller and/or system associated with operation or measurement of a machine when data comprising different numeric values is received and evaluated. Further technical effects can include improved numeric accuracy in processing certain data comprising different numeric values associated with operation or measurement of a machine. Further technical effects can include improved numeric accuracy in processing certain data associated with any numeric measurement of a condition, environment, instance, and/or any combination of the foregoing.

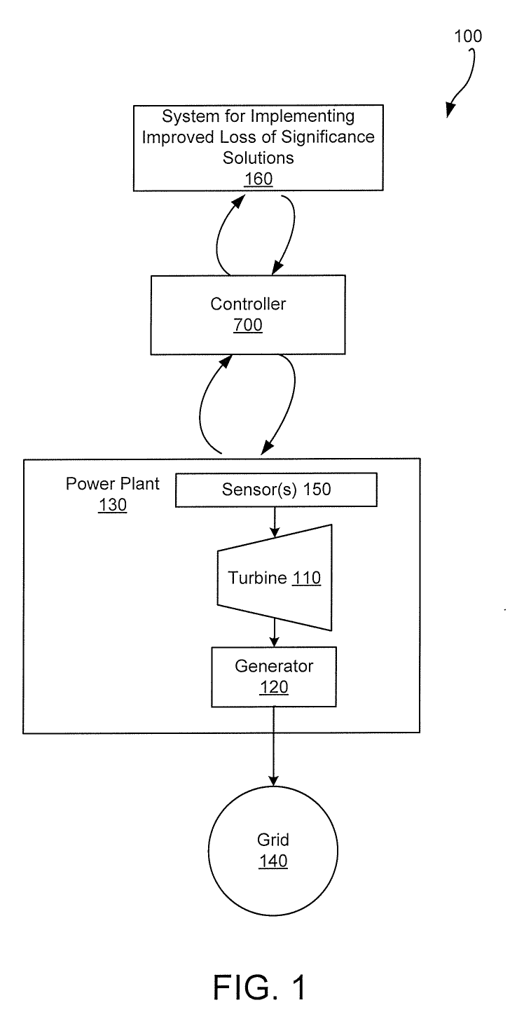

Referring now to FIG. 1, a block diagram illustrates an example system environment 100 suitable for implementing improved loss of significance solutions in accordance with certain embodiments of the disclosure. By way of example, the environment 100 can include a machine, such as gas turbine 110 and generator 120, or other machine and/or power plant component, associated with a power plant 130, in accordance with one or more example embodiments of the disclosure. The power plant 130 may be a combined cycle power plant. The gas turbine 110 may produce mechanical power and exhaust energy may be used to convert water to steam. The produced steam may be used by an associated steam turbine to produce additional mechanical power. To convert the mechanical power into electrical power, the gas turbine 110 can be mechanically coupled to a generator 120, and the steam turbine can be mechanically coupled to another generator. One or more of the generators, including 150, may be coupled to a grid 140 and provide a supply of electricity to the grid 140. The grid 140 may include various conventional distribution systems.

One will recognize that components of the power plant 130 may include at least a turbine 110, a steam turbine, a generator 120 as well as other known power plant components, such as one or more sensors 150, rotor, turbine, turbine blades or buckets, a condenser, a superheater, an evaporator, a drum, an economizer, a reheater, a valve, a controller, a pipe, a pump, a pre-heater, a fuel heater, a flow splitter, a flow mixer, an attemperator, a duct burner, a selective catalytic reduction unit, a steam condenser, a condenser hot well, and so forth.

The configuration of the power plant 130 illustrated by FIG. 1 is just one of any number of possible configurations. Other configurations of power plants can be used including those with a turbine only, or two or more turbines providing exhaust energy to two or more heat recovery steam generators that in turn feed a single steam turbine to provide combined power, and so forth.

In any instance, operation of the power plant 130 may be managed through a controller 700. The controller 700 may interact with the power plant 130 for enhancing operations of a power plant. The system for implementing improved loss of significance solutions, shown as 160, may enhance operations of the controller 600, power plant 130, and/or power plant components.

The system 160 can utilize one or more methodologies disclosed herein to improve processing efficiency and/or computational speed of the controller 700, which may be associated with operation or measurement of the power plant 130 or any number of power plant components when data comprising different numeric values is received and evaluated. Further, the system 160 can utilize one or more methodologies disclosed herein to improve numeric accuracy in processing certain data comprising different numeric values associated with operation or measurement of the power plant 130 and/or any number of power plant components.

Any number of system environments and/or system embodiments can be implemented with improved loss of significance solutions in accordance with certain embodiments of the disclosure. Further, the system environment 100 described above is one implementation example with respect to a power plant, power plant component, and/or turbine.

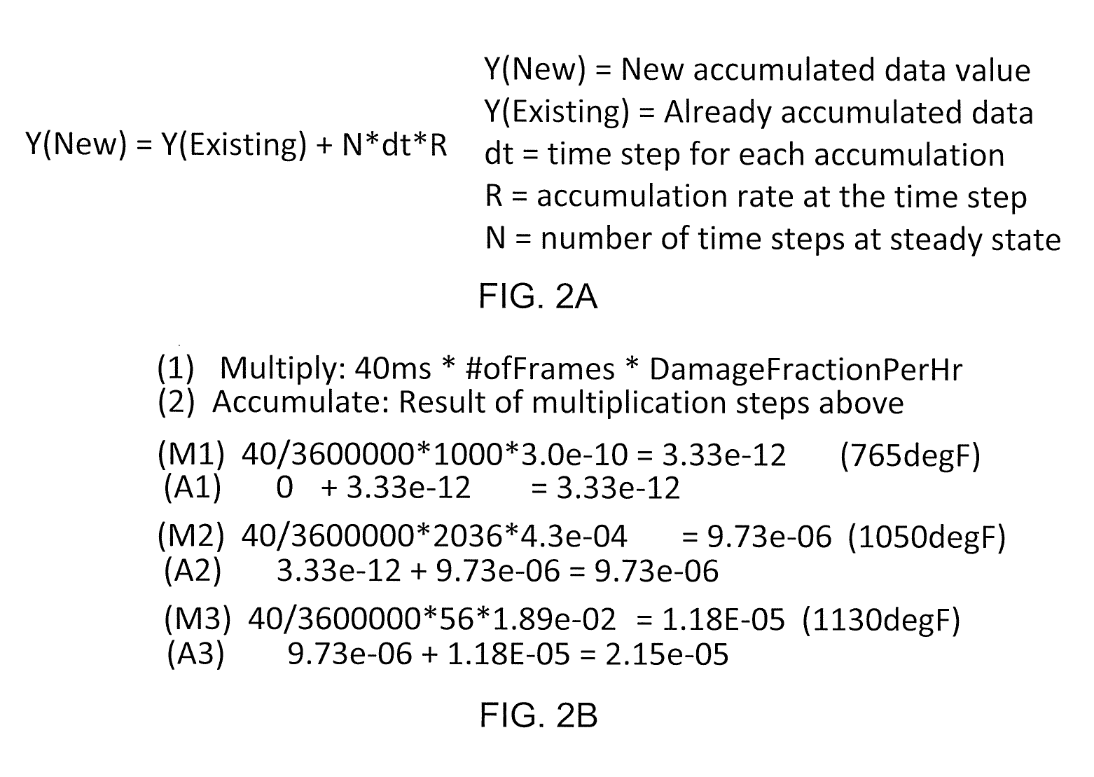

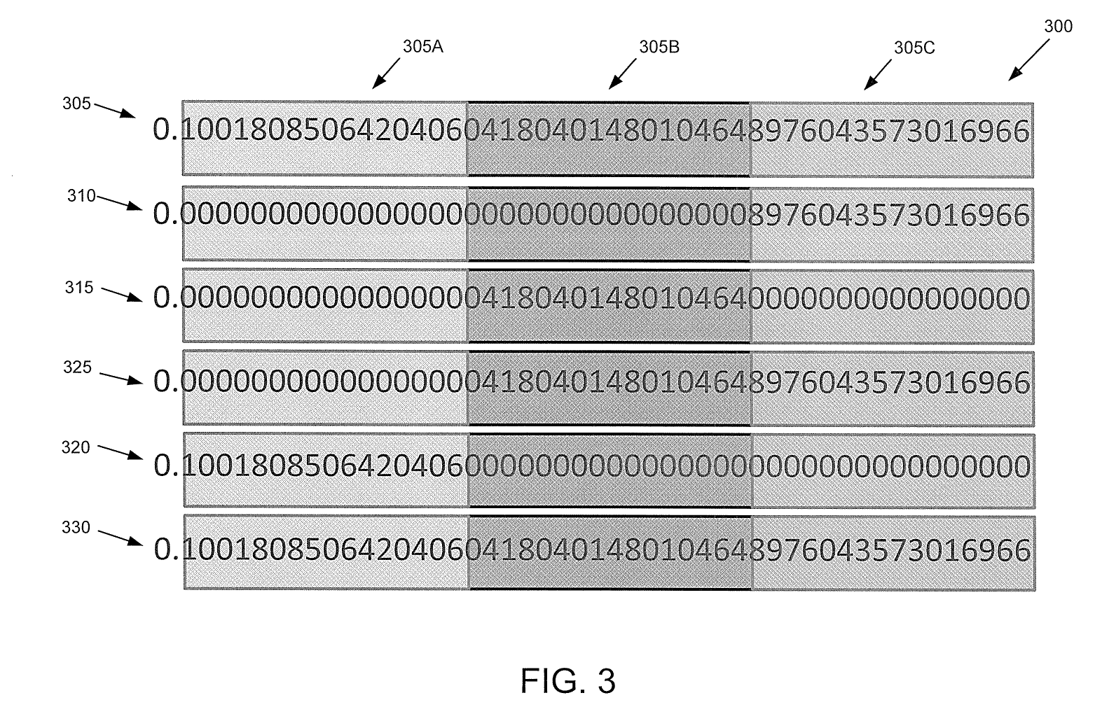

Turning to FIG. 2A, an example loss of significance calculation for a method is shown in accordance with certain embodiments of the disclosure. In this embodiment, a general algorithm for improved loss of significance can be implemented as: Y(New)=Y(Existing)+N*dt*R, where Y(New)=new accumulated value, Y(Existing)=already accumulated data, N=number of time steps at a steady state, dt=time step for each accumulation, and R=accumulation rate at the time step. This iterative method can be implemented over time for any number steps and/or instances to improve loss of significance in calculations associated with a string of numeric data.

FIG. 2B illustrates example calculations using the algorithm shown in FIG. 2A for a method in accordance with certain embodiments of the disclosure. In this embodiment, damage to a power plant component, such as a turbine blade or bucket, can be calculated and improved loss of significance in the calculations can be achieved. In (1), values for the variables in the algorithm can be N=40 ms (milliseconds) times dt=a number of frames (#ofFrames) times R=damage fraction per hour (DamageFractionPerHr). In (2), the initial Y(existing)=the result of the multiplication in (1). Thus, in (M1), a measurement of a power plant component at about 765 degrees Fahrenheit, can be calculated as 40/3600000 times 1000 times 3.0 e-10, which equals 3.33 e-12. In (A1), the already accumulated data, Y(Existing), would initially start at 0, and the multiplication result in (M1) would be added to 0 as 0+3.33 e-12=3.33 e-12, to result in a new accumulated value of Y(New).

Next in (M2), a measurement of the power plant component at about 1050 degrees Fahrenheit, can be calculated as 40/3600000 times 2036 times 4.3 e-04, which equals 9.73 e-06. In (A2), the new accumulated data value, Y(new), from (A1) is used as the already accumulated data, Y(Existing), and multiplication result in (M2) would be added to 3.33 e-12 as 3.33 e-12+9.73 e-06, which equals 9.73 e-06.

Next in (M3), a measurement of a power plant component at about 1130 degrees Fahrenheit, can be calculated as 40/3600000 times 56 times 1.890 e-02, which equals 1.18 e-05. In (A3), the new accumulated data value, Y(new), from (A2) is used as the already accumulated data, Y(Existing), and multiplication result in (M3) would be added to 9.73 e-06 as 9.73 e-06+1.18 e-05, which equals 2.15 e-05.

As needed, additional multiplication (M) and accumulation (A) operations can be applied to further calculate and accumulate data to represent damage to a power plant component and improved loss of significance in the associated calculations can be achieved.

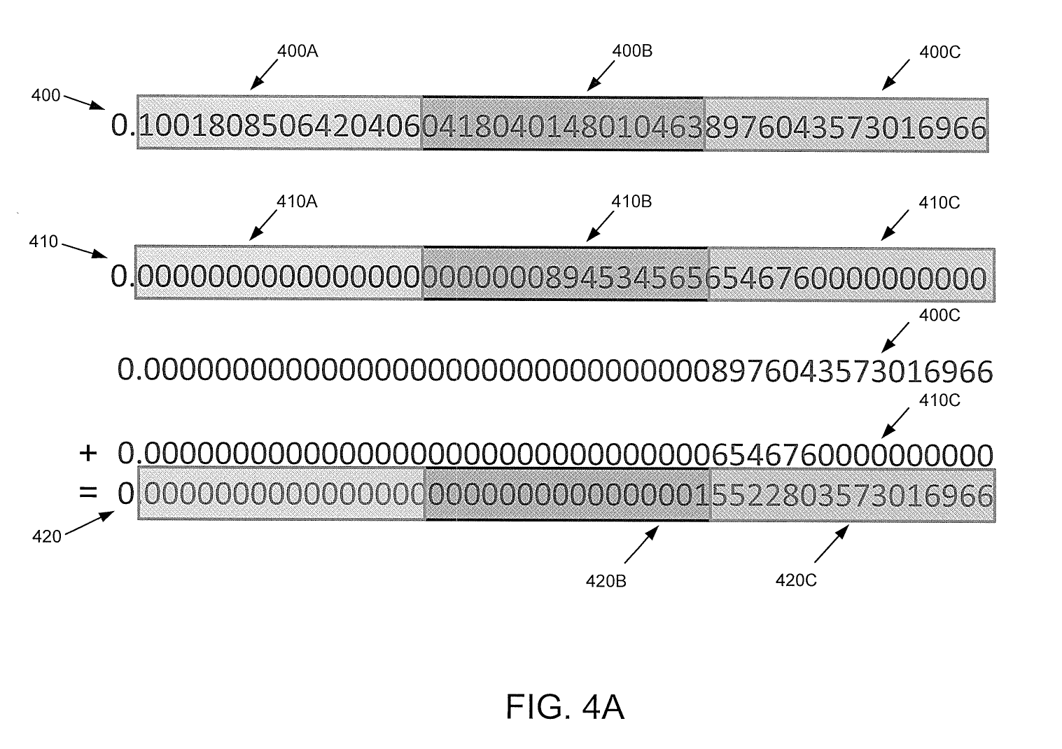

Turning to FIG. 3, which illustrates an example numeric string with segments in accordance with certain embodiments of the disclosure, a set of data 300 including a numeric string 305 of sequential numeric digits is shown. The data 300 could be received, for example, by a processor monitoring measurements from a machine, such as a controller 600 monitoring a power plant 130 in FIG. 1. In other embodiments, a numeric string may represent data associated with operation or measurement of a machine, such as, a power plant or power plant component. In one example, one or more sensors associated with a power plant component, such as a turbine rotor, can provide a numeric string of data to a controller, processor, or computer. In another example, a processor and/or computer may provide a numeric string of data as a result of performing calculations based on data received from one or more sensors and/or other inputs. In any instance, the numeric string of data can be any length of digits.

In any instance, the numeric string 305 can be separated, by the processor, into any number of segments of sequential numeric digits, such as three segments, each segment 16 bits or numeric digits in length, shown in this example, labeled as 305A, 305B, 305C, though any number of segments and any length of segments can be selected. Each of the three segments 305A, 305B, 305C can be respectively separated and stored in a memory associated with the controller 600, such as segment 310 representing 305C, segment 315 representing 305B, and segment 320 representing 305A. Thus, in segment 310, only the corresponding sequential numeric digits of segment 305C, that is “8976043573016966” are separated from the string 300 and stored as segment 310. Likewise, in segment 315, only the corresponding sequential numeric digits of segment 305B, that is “0418040148010464” are separated from the string 300 and stored as segment 315. Another segment representing corresponding sequential numeric digits of segment 305A, that is “1001808506420406” could be separated from the string 300 and stored as another segment 320.

Thus, in the embodiment shown in FIG. 3, segment 305A or 320 can be designated as a first alpha segment, segment 305B or 315 can be designated as a first beta segment, and segment 305C or 310 can be designated as a first charlie segment.

Similar to the string 305 and segments 305A, 305B, 305C described above, one or more subsequent strings of sequential numeric digits can also be respectively segmented. For example, after a first string 310 of data is segmented into at least a first alpha segment 305A and a first beta segment 305B, a second string of data can be segmented into at least a second alpha segment and a second beta segment. A third string of data could be segmented into at least a third alpha segment and a third beta segment. The separation of subsequent strings of sequential numeric digits into one or more respective segments can be repeated as needed.

In certain embodiments, a length of one or more segments can be determined by a user based on experience and/or by choice. Generally, the greater the length of segments that are determined, the more precise the loss of significance calculations that can result. For example, if a string length is 30 numeric digits, segment lengths can be determined to cover the range of 1 to 30 digits. In some embodiments, the segment lengths can be determined to be equal in length, such as three segments of 10 digit length for a 30 digit string; while in other embodiments, the segment lengths can vary in length. In this example, three segments of 10 digit length can be determined to suitably cover the string of 30 digits. In certain embodiments, a string and/or segment can be 16 bits in length. In other embodiments, any number of segments, any length of segments, and any number of bit lengths can be determined.

In certain embodiments, a string of data can represent a condition which can include, but may not be limited to, damage, remaining life, creep life, or creep damage. For example, one or more sensors, such as 150 in FIG. 1, can collect data which may represent measurements of a condition by the one or more sensors. The data may be in form of a numeric string. Depending on the sensitivity of the one or more sensors, the data string can be any length of numeric digits.

Turning back to FIG. 3, segments can be accumulated together. For example, segment 310 and segment 315 can be summed or accumulated to result in an accumulated value 325. The accumulated value 325 and another segment, such as 320, can be further summed or accumulated to result in a subsequent accumulated value 330. However, in embodiments of the disclosure, the accumulation of similar segments, that is, accumulation of a first alpha segment with one or more subsequent alpha segments, a first beta segment with one or more subsequent beta segments, and so on, can result in improvements in the loss of significance solutions.

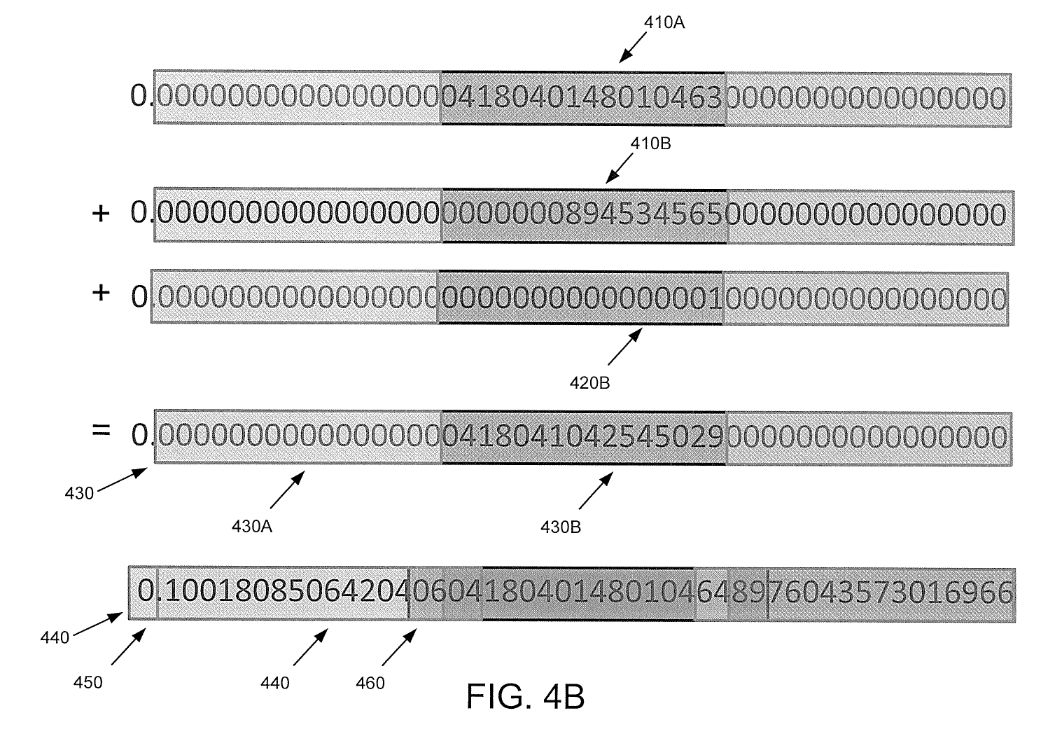

As further described below with respect to FIG. 4A, an initial string 400 of data may exist, and a new or subsequent string 410 of data may be received. To implement an embodiment of the disclosure, the initial string 400 can be separated into at least two segments comprising an alpha segment and a beta segment. In this example, the initial string 400 is separated into an alpha segment 400A, a beta segment 400B, and a charlie segment 400C. Further, the new or subsequent string 410 can be separated into at least two segments comprising a subsequent alpha segment and a subsequent beta segment. In this example, the new or subsequent string 410 is separated into a subsequent alpha segment 410A, a subsequent beta segment 410B, and a subsequent charlie segment 410C.

Next, a determination can be made that the initial string 400 and the new or subsequent string 410 have numeric data in the respective beta segments 400B, 410B and in the respective charlie segments 400C, 410C. When numeric data exists in at least 2 similar segments, such as a first beta segment 400B and a subsequent beta segment 410B, the corresponding beta segments 400B and 410B can be accumulated. Likewise, when numeric data exists in at least 2 similar segments, such as a first charlie segment 400C and a subsequent charlie segment 410C, the corresponding charlie segments 400C and 410C can be accumulated. In this example, the corresponding charlie segments 400C and 410C are initially accumulated to obtain an accumulated result 420. Though the accumulated result 420 has a value in the respective beta segment 420B, the accumulated result 420 can still be stored in the charlie segment 420C and the result can be determined to be an overflow. The portion of the result in the beta segment 420B, or the overflow result, can be subtracted from the accumulated charlie segment 420C of the accumulated result 420, and added to the subsequent beta segment 410B of the new or subsequent string 410. That is, since the accumulated result 420 exceeds the numeric length, 16 bits or digits, for the accumulated charlie segment 420C, and the result 420 overflows into the adjacent accumulated beta segment 420B, the accumulated result 420 should be split.

Thus, as shown in FIG. 4B, the accumulated result 420 from FIG. 4A is split by taking the portion of the result in the beta segment 420B, or the overflow result, and accumulating the overflow portion with the subsequent beta segment 410B and the beta portion 400B of the initial string 400. The new accumulated result 430, particularly in the respective beta segment 430B, represents the sum of the three respective beta portions 400B, 410B, 420B of the initial string 400, new or subsequent string 410, and accumulated result 420. Since, in this example, there is no overflow value in the alpha segment 430A of the new accumulated result 430, no further splitting is needed.

Thus, in embodiments of the disclosure, each corresponding segment, such as a first alpha segment, a second alpha segment, a third alpha segment, and so on, can be accumulated or otherwise added together. Likewise, a first beta segment, a second beta segment, a third beta segment, and so on, can be accumulated or otherwise added together. Similarly, a first charlie segment, a second charlie segment, a third charlie segment, and so on, can be accumulated or otherwise added together. As needed, any overflow results in any respective segments of the accumulated results can be subtracted from a segment and added to the adjacent segment, or otherwise split from a segment and accumulated in the adjacent segment, as described in FIGS. 4A and 4B.

In some embodiments, a particular string, such as 440 in FIG. 4B, can have a segment 440A with one or bands 450, 460 at either or both ends of the segment. Each band 450, 460 can be one or more bits or digits in length. The bands 450, 460 can permit for an overflow of accumulated results from an adjacent segment to result in a relatively accurate solution. That is, if storage capability is in the range of 20 bits or digits, then each segment can be limited to 16 bits or digits, leaving a 4 bit or digit total band length, which could be allocated 2 bits or digits on either side of a particular segment.

In any instance, each of the accumulated values for the alpha segments, beta segments, charlie segments, and so on, can be monitored against a target value, such as an upper threshold and/or a lower threshold. Based at least in part on meeting or exceeding the target value, an alert and/or message indicative of the target value being met can be generated.

In certain embodiments, based at least in part on the accumulated alpha value, beta value, charlie value, and so on, an excess value that exceeds the target value can be determined. The excess value can be added to an adjacent accumulated value. That is, if a relatively lower accumulated beta value is adjacent to a relatively higher accumulated alpha value, the excess value of the accumulated beta value can be added to the adjacent accumulated alpha value.

In certain embodiments, based at least in part on meeting or exceeding the target value, an alert or message can be generated. The alert or message can be indicative of the target value being met. For example, a controller, processor, or computer can monitor any number of accumulated values against respective target values and/or the same target value. The monitoring can be a comparison of an accumulated value against a threshold value. For instance, an accumulated alpha value representing an amount of calculated damage to a power plant component can be compared against a threshold value representing a predefined amount of damage to a power plant component. When a particular target value is met or exceeded by an accumulated value, the controller, processor, or computer can generate a signal or otherwise generate an alert or message indicative of the target value being met. The alert or message can be visual, tactile, audible, and/or any combination of signals. In some instances, a user interface device and/or an I/O device can be used to output the alert or message.

Further, in certain embodiments, based at least in part on the alert, a recommendation can be generated for a corrective action or a signal to initiate a corrective action with respect to a power plant component. For example, a controller, processor, or computer can receive an alert or message indicating a target value is met or exceeded. Based at least in part on the alert or message, controller, processor, or computer can evaluate any number of accumulated values against respective target values and/or the same target value, and generate a suitable corrective action or a signal to initiate a corrective action to transmit to a recipient, such as a component of a machine or a power plant component.

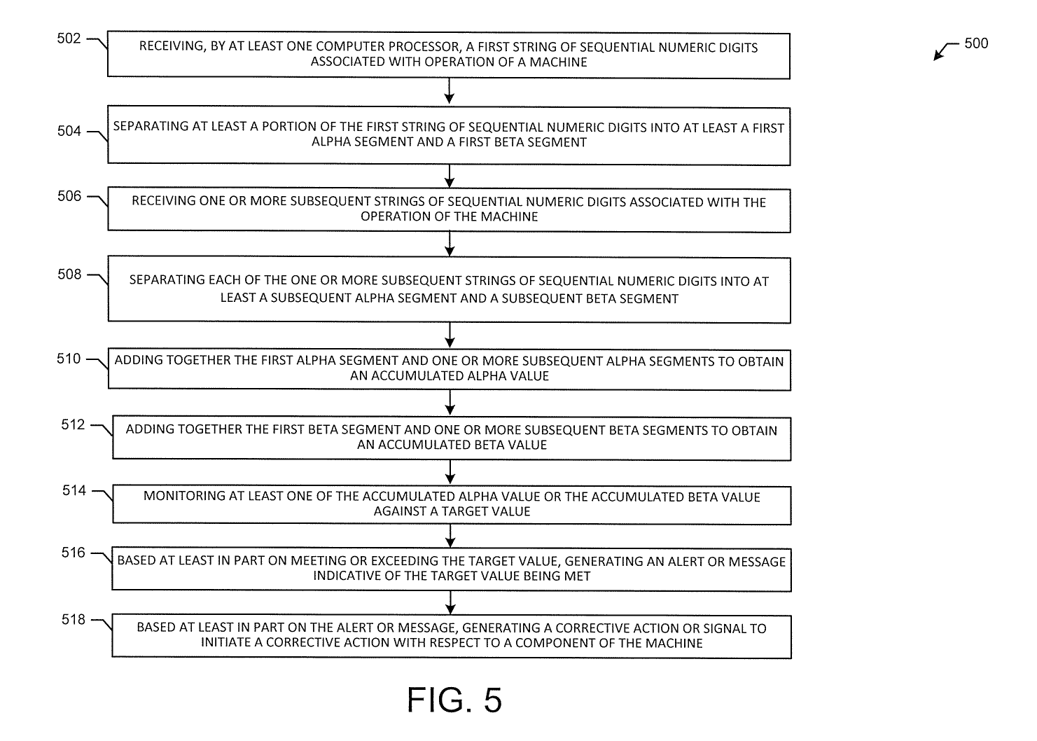

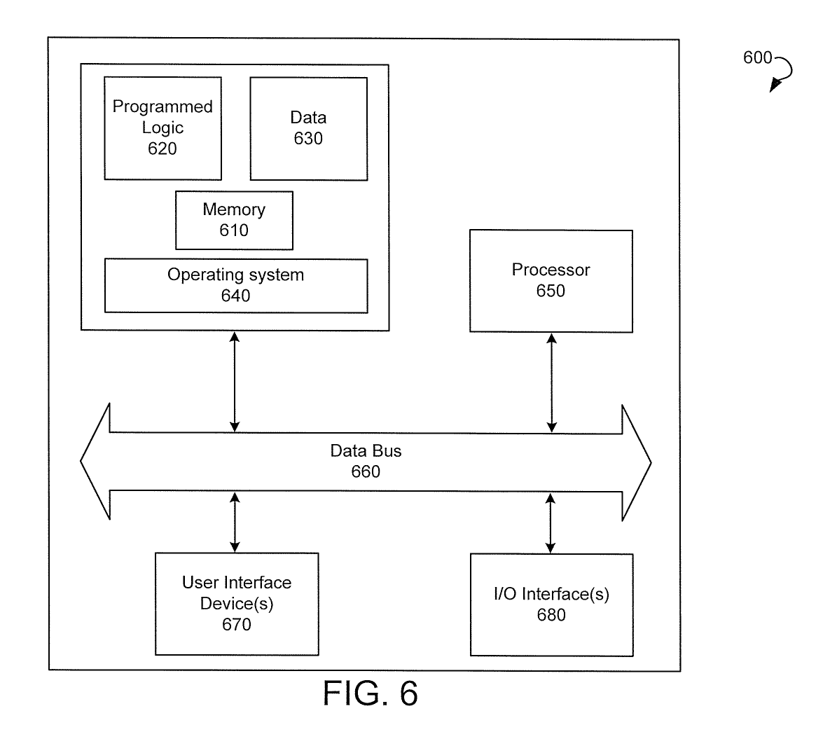

FIG. 5 illustrates an example method in accordance with certain embodiments of the disclosure. Some or all of the operations in method 500 can be implemented using the system environment 100 in FIG. 1 and/or the controller 600 in FIG. 6. The method 500 begins at block 502, at which an operation of receiving, by at least one computer processor, a first string of sequential numeric digits associated with operation of a machine can be performed.

Block 502 is followed by block 504, in which an operation of separating at least a portion of the first string of sequential numeric digits into at least a first alpha segment and a first beta segment.

Block 504 is followed by block 506, in which an operation of receiving one or more subsequent strings of sequential numeric digits associated with the operation of the machine can be performed.

Block 506 is followed by block 508, in which an operation of separating each of the one or more subsequent strings of sequential numeric digits into at least two subsequent segments of subsequent sequential numeric digits can be performed, wherein each subsequent segment can include at least a subsequent alpha segment and a subsequent beta segment.

Block 508 is followed by block 510, in which an operation of adding together the first alpha segment and one or more subsequent alpha segments to obtain an accumulated alpha value can be performed.

Block 510 is followed by block 512, in which an operation of adding together the first beta segment and one or more subsequent beta segments to obtain an accumulated beta value can be performed.

Block 512 is followed by block 514, in which an operation of monitoring at least one of the accumulated alpha value or the accumulated beta value against a target value can be performed.

Block 514 is followed by block 516, in which an operation of generating, based at least in part on meeting or exceeding the target value, an alert or message indicative of the target value being met can be performed.

Block 516 is followed by block 518, in which an operation of generating, based at least in part on the alert or message, a corrective action or signal to initiate a corrective action with respect to a component of the machine can be performed.

In at least one aspect of an embodiment, the method 500 can further include an operation of based at least in part on the accumulated beta value, determining an excess value that exceeds the target value, and adding the excess value to the accumulated alpha value.

In at least one aspect of an embodiment, the method 500 can further include an operation of separating at least a portion of the first string of sequential numeric digits into at least a first alpha segment and a first beta segment, which can further include determining a length of the first alpha segment and a length of the first beta segment.

In at least one aspect of an embodiment, each of the first alpha segment, second alpha segment, the one or more subsequent alpha segments and the one or more subsequent beta segments are 16 bits in length.

In at least one aspect of an embodiment, the target value represents a value associated with a threshold indicating a predefined amount of a condition to a machine or a machine component.

In at least one aspect of an embodiment, the condition can represent at least one of the following: damage, remaining life, creep life, or creep damage.

In at least one aspect of an embodiment, the machine can include a turbine or a power plant component.

Other embodiments can include fewer or greater numbers of operations, and one will recognize the applicability of the method to other contexts.

FIG. 6 depicts a block diagram illustrating an example controller 600 for implementing improved loss of significance solutions, in accordance with an embodiment of the disclosure. More specifically, the elements of the controller 600 may be used to implement improved loss of significance solutions with respect to a power plant, such as 130 shown in FIG. 1. The controller 600 may include a memory 610 that stores programmed logic 620 (e.g., software) and may store data 630 collected from one or more sensors, such as shown as 150 in FIG. 1, including data such as operation data and/or measurement data of a power plant, and the like. The memory 610 also may include an operating system 640.

A processor 650 may utilize the operating system 640 to execute the programmed logic 620, and in doing so, may also utilize the data 630. A data bus 660 may provide communication between the memory 610 and the processor 650. Users may interface with the controller 600 via at least one user interface device 670, such as a keyboard, mouse, control panel, or any other devices capable of communicating data to and from the controller 600. The controller 600 may be in communication with the power plant online while operating, as well as in communication with the power plant offline while not operating, via an input/output (I/O) interface 680. Additionally, it should be appreciated that other external devices or multiple other power plants may be in communication with the controller 600 via the I/O interface 680. In the illustrated embodiment of the disclosure, the controller 600 may be located remotely with respect to the power plant; however, it may be co-located or even integrated with the power plant. Furthermore, the controller 600 and the programmed logic 620 implemented thereby may include software, hardware, firmware, or any combination thereof. It should also be appreciated that multiple controllers 600 may be used, whereby different features described herein may be executed on one or more different controllers 600.

References are made to block diagrams of systems, methods, apparatuses, and computer program products according to example embodiments of the disclosure. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments of the disclosure disclosed and that modifications and other embodiments of the disclosure are intended to be included within the scope of the appended claims. Although specific terms are employed herein, they are used in a generic and descriptive sense only and not for purposes of limitation.

1. A computer-implemented method comprising:
receiving, by at least one computer processor, a first string of sequential numeric digits associated with operation of a machine;
separating at least a portion of the first string of sequential numeric digits into at least a first alpha segment and a first beta segment;
receiving one or more subsequent strings of sequential numeric digits associated with the operation of the machine;
separating each of the one or more subsequent strings of sequential numeric digits into at least two subsequent segments comprising at least a subsequent alpha segment and a subsequent beta segment;
adding together the first alpha segment and one or more subsequent alpha segments to obtain an accumulated alpha value;
adding together the first beta segment and one or more subsequent beta segments to obtain an accumulated beta value;
monitoring at least one of the accumulated alpha value or the accumulated beta value against a target value; and
based at least in part on meeting or exceeding the target value, generating an alert or message indicative of the target value being met.

2. The computer-implemented method of claim 1, further comprising:
based at least in part on the accumulated beta value, determining an excess value that exceeds the target value; and
adding the excess value to the accumulated alpha value.

3. The computer-implemented method of claim 1, wherein separating at least a portion of the first string of sequential numeric digits into at least a first alpha segment and a first beta segment, comprises:
determining a length of the first alpha segment and a length of the first beta segment.

4. The computer-implemented method of claim 1, wherein each of the first alpha segment, second alpha segment, the one or more subsequent alpha segments and the one or more subsequent beta segments are 16 bits in length.

5. The computer-implemented method of claim 1, wherein the target value represents a value associated with a threshold indicating a predefined amount of a condition to a machine or a machine component.

6. The computer-implemented method of claim 1, wherein the first string represents a condition comprising at least one of the following: damage, remaining life, creep life, or creep damage.

7. The computer-implemented method of claim 1, wherein the machine comprises a turbine or a power plant component.

8. A system comprising:
a controller; and
a memory comprising computer-executable instructions operable to:
receive, by at least one computer processor, a first string of sequential numeric digits associated with operation of a machine;
separate at least a portion of the first string of sequential numeric digits into at least a first alpha segment and a first beta segment;
receive one or more subsequent strings of sequential numeric digits associated with the operation of the machine;
separate each of the one or more subsequent strings of sequential numeric digits into at least two subsequent segments comprising at least a subsequent alpha segment and a subsequent beta segment;
add together the first alpha segment and one or more subsequent alpha segments to obtain an accumulated alpha value;
add together the first beta segment and one or more subsequent beta segments to obtain an accumulated beta value;
monitor at least one of the accumulated alpha value or the accumulated beta value against a target value; and
based at least in part on meeting or exceeding the target value, generate an alert or message indicative of the target value being met.

9. The system of claim 8, wherein the computer-executable instructions are further operable to:
based at least in part on the accumulated beta value, determine an excess value that exceeds the target value; and
add the excess value to the accumulated alpha value.

10. The system of claim 8, wherein the computer-executable instructions operable to separate at least a portion of the first string of sequential numeric digits into at least two segments comprising at least a first alpha segment and a first beta segment, comprise computer-executable instructions operable to:
determine a length of the first alpha segment and a length of the first beta segment.

11. The system of claim 8, wherein each of the first alpha segment, second alpha segment, the one or more subsequent alpha segments and the one or more subsequent beta segments are 16 bits in length.

12. The system of claim 8, wherein the target value represents a value associated with a threshold indicating a predefined amount of a condition to a machine or a machine component.

13. The system of claim 8, wherein the first string represents a condition comprising at least one of the following: damage, remaining life, creep life, or creep damage.

14. The system of claim 8, wherein the machine comprises a turbine or a power plant component.

15. A system comprising:
a power plant component;
a controller; and
a memory comprising computer-executable instructions operable to:
receive, by at least one computer processor, a first string of sequential numeric digits associated with operation of the power plant component;
separate at least a portion of the first string of sequential numeric digits comprising at least a first alpha segment and a first beta segment;
receive one or more subsequent strings of sequential numeric digits associated with the operation of the power plant component;
separate each of the one or more subsequent strings comprising at least a subsequent alpha segment and a subsequent beta segment;
accumulate the first alpha segment and one or more subsequent alpha segments to obtain an accumulated alpha value;
accumulate the first beta segment and one or more subsequent beta segments to obtain an accumulated beta value;
monitor at least one of the accumulated alpha value or the accumulated beta value against a target value;
based at least in part on the accumulated beta value, determine an excess value that exceeds the target value;
add the excess value to the accumulated alpha value;
based at least in part on meeting or exceeding the target value, generate an alert or message indicative of the target value being met; and
based at least in part on the alert, facilitate generating a recommendation for a corrective action or a signal to initiate a corrective action with respect to the power plant component.

16. The system of claim 15, wherein the computer-executable instructions operable to separate at least a portion of the first string comprising at least a first alpha segment and a first beta segment, comprise computer-executable instructions operable to:
based at least in part on a condition associated with operation of the power plant component, determine a length of the first alpha segment and a length of the first beta segment.

17. The system of claim 15, wherein each of the first alpha segment, second alpha segment, the one or more subsequent alpha segments and the one or more subsequent beta segments are 16 bits in length.

18. The system of claim 15, wherein the target value represents a value associated with a threshold indicating a predefined amount of a condition to a power plant component.

19. The system of claim 15, wherein the first string represents a condition comprising at least one of the following: damage, remaining life, creep life, or creep damage.

20. The system of claim 15, wherein the first string of sequential numeric digits associated with operation of the power plant component comprises measurement data from one or more sensors.
